(19) United States
(12) Patent Application Publication
(10) Pub. No.: US 2001/0002037 A1
(43) Pub. Date: May 31, 2001

(54) IN-FIELD SUGAR CANE PROCESSOR

(76) Inventor: TREVOR ESSEX CULLINGER, QUEENSLAND (AU)

Correspondence Address: JAMES H MARSH JR, SHOOK HARDY & BACON LLP, 1200 MAIN STREET, KANSAS CITY, MO, 641052118

(21) Appl. No.: 09/410,258

(22) Filed: Sep. 30, 1999

(51) Int. Cl. B02C 19/12

(52) U.S. Cl. 241/101.742

(57) ABSTRACT

An apparatus and method for extracting sugar-containing juice from sugar-containing plant matter, such as sugar cane. The apparatus is adapted to be installed in or near the field in which the plant matter is to be harvested. The apparatus comprises an inlet means for receiving the plant matter, a comminuting means for finely comminuting the received plant matter, and a separating means for separating the sugar-containing juice from the finely comminuted plant matter. Use of the apparatus at or near the site of harvest reduces the quantity of fibrous material transported to the sugar mill. It also allows return to the field of much of the fibrous matter that is at present lost in the harvesting process.

### FIELD OF THE INVENTION

This invention relates to in-field or near-field processing equipment and in particular but not limited to an in-field processing machine for the processing of sugar cane for the purpose of extracting sugar cane juice therefrom.

### BACKGROUND TO THE INVENTION

The sugar cane industry is an important agricultural industry. For example, in Australia, farmers currently produce in excess of 37 million tonnes of sugar cane annually, resulting in the production of approximately 5 million tonnes of raw sugar per annum. Approximately 70% of the sugar produced in Australia is exported overseas.

Sugar cane harvesting in Australia and other first world countries is typically highly mechanised. Competition from subsidised overseas production and emerging Third World producers, combined with fluctuating world market prices for the product, does, however, necessitate the need for the Australian industry to continually increase its productivity and efficiency to maintain its standing as a reliable supplier of high quality sugar.

Australia is one of the major sugar exporting nations but is only one of a number of sugar producing countries. Other significant sugar producing nations or regions include Brazil, Argentina, Cuba and other Caribbean Islands, Thailand, India, Southern Africa, and United States of America.

Regardless of the country of origin of sugar produced from sugar cane, the production of the raw sugar follows a basic universal procedure.

Sugar cane is grown over a period of months in the field. When ripe, the sugar cane plants are harvested, utilising a variety of methods. In more technologically advanced countries like Australia, the sugar cane is harvested by mechanical harvesters which cut the cane plants off proximate the ground and feed the cane stalks through a series of knives to produce billets of sugar cane (i.e. cane cut into pieces).

In less technologically advanced countries, manual labour is employed to harvest the sugar cane.

Regardless of the technological advancement of the different sugar cane producing nations, the sugar cane is processed in sugar mills which are often situated long distances from the sugar cane fields. The harvested cane is transported to the sugar mills using a great variety of transportation systems.

Once at the mill, the cane billets are subjected to processes whereby the cane is crushed to release the juice which is then further processed to produce sugar crystals. This juice can then undergo further processing or refining either in the mill or at a sugar refinery before being in a form suitable for consumption.

Although the invention to be discussed below relates to the principle of processing of sugar cane in or near the field of harvest, the invention could also be modified to facilitate the in-field or near-field processing of many other juicable products, for example, sugar beet or other sugar/saccharin containing bamboos, grasses or vegetables.

### SUMMARY OF THE INVENTION

The present invention provides an apparatus and method that can be used at or near the site of the harvest of the sugar-containing plant matter. Hereinafter, it is to be understood that in-field processing is to be taken to encompass processing undertaken near the site of harvest of the plant matter but not necessarily in the actual field of harvest.

The apparatus can be used in the production of raw sugar, or even the separation of the sugar components from the juice, for example, to sugar crystals and molasses. In one embodiment, the apparatus can be used in the production of sugar cane juice. In another embodiment, the apparatus can be used to process raw sugar. In a still further embodiment, the apparatus can be used to separate the raw sugar crystals into brown sugars and molasses. This invention also preferably relates to a method or process of extracting or separating either individually or in combination each separate component of the sugar cane from the sugar cane juice.

According to a first aspect, the present invention is an apparatus for extracting sugar-containing juice from sugar-containing plant matter, the apparatus comprising:

an inlet means for receiving the plant matter;

a comminuting means for finely comminuting the received plant matter: and

a separating means for separating the sugar-containing juice from the finely comminuted plant matter.

According to a second aspect, the present invention consists in a process of extracting sugar-containing juice from sugar-containing plant matter using an apparatus having at least an inlet means for receiving the plant matter, a comminuting means for finely comminuting the received plant matter, and a separating means for separating the sugar-containing juice from the finely comminuted plant matter, the process comprising the steps of:

feeding the plant matter to the inlet means;

finely comminuting the plant matter by passing it through the comminuting means; and

separating the sugar-containing juice from the plant matter in the separating means.

The present apparatus will facilitate the extraction of sugar cane juice in or near the field of harvest of the sugar-containing plant matter. This is opposed to the concept of milling processes being performed in centralised milling facilities that are often a significant distance from the site of harvest. The invention in another embodiment will facilitate the extraction of raw sugar in or near the field. The invention in another design will facilitate the extraction of any, or all, either individually, or in any combination, or state, of the components of a juice bearing sugar cane, sugar beet or other sugar/saccharin-containing bamboos, grasses or vegetables. Where necessary, hereinafter, the apparatus and method will be described with reference to the processing of sugar cane with it being appreciated that the apparatus and method could be used, with suitable modification, in the in-field or near-field processing of other sugar-containing plant matter.

The apparatus can be of any suitable shape, fabricated of any suitable material or materials, and utilise any appropriate technology. The apparatus can be applied or manufactured as an independent processing unit or as part of a combined harvesting processing train or as part of an integrated harvester.

The advantages of the present apparatus are manifold. Currently, sugar cane harvesting methods result in the removal of much and in some cases all of the sugar cane crop from the field. This loss of biomass must be compensated for by the application of fertilizer to the fields to maintain crop production levels. At the mill, the fiber remaining from the crushing process is often used by the mill as fuel to run boilers. It is also often sold by the mill as stockfeed or fertilizer, or used in the production of building material. The cane farmer gains only nominal direct commercial advantage from the remaining fiber that is transported from the field to the mill.

The invention allows the fiber remaining after the in-field or near-field processing of the sugar cane to be returned to the field as fertilizer or to be used in what ever way the farmer desires. In effect, the in-field or near-field processor results in only the sugar cane juice being removed from the field with preferably all other elements of the sugar cane crop being left in the field to be used by the farmer for what ever purpose it is seen fit.

Coupled with the practice of green cane harvesting which has now been trialed or in use in many Australian cane growing districts and is increasing in application worldwide, the return of cane fibrous material to the field could well lead to a decrease in the requirement for application of artificial fertilizers to the fields to maintain crop yield levels. Accordingly, the present apparatus and its use allows the farmer to gain the maximum benefits from sugar cane production.

The apparatus also leads to a significant reduction in the volume of product which needs to be transported to the sugar mill. Sugar cane juice accounts for the largest percentage of the total mass of the sugar cane crop, therefore the change of mass will depend on the amount of fiber left in the field. Thus, the reduced volume of material which needs to be to transported away from the farm has the potential to result in reduced transport costs, which in turn leads to increased financial return to the producers. Likewise, the in-field processor and the production of juice in or near the field eliminates the need for sugar mills to necessarily possess large crushing plant which requires appreciable amounts of capital investment, energy and maintenance. This provides mill operators with an opportunity to increase mill capacity by incremental expansion compared to the normal present requirement of periodic large mill upgrades or new construction. The potential financial advantage for the milling sector of the sugar industry is, accordingly, also substantial once these factors are taken into consideration.

Another benefit of the apparatus is the reduced infrastructure requirement needed in expansion of existing cane growing areas or the development of new growing areas.

Because of the envisaged increased return to growers, it is envisaged by the present inventor that it may be feasible in the future to develop new growing areas dedicated to the production of ethanol. The idea of ethanol being produced from sugar cane is not a new concept, and is a product of the Plane Creek sugar mill in the Mackay region of Queensland, Australia. More than a decade ago, much discussion centered around this proposal. However, the large scale production of ethanol from sugar cane never eventuated because the farmer could not be guaranteed the same price for cane as that received for cane used to produce sugar. Ethanol is considered a clean fuel compared to common fuels in use today. With Australia and other countries, such as the United States of America, coming under increasing pressure to reduce greenhouse gas emissions, the use of ethanol as opposed to other traditional fuels could be seen as a positive, environmentally friendly step. The use of ethanol as a fuel to drive the sugar mill is also possibly a more environmentally responsible process than the burning of bagasse.

Yet another advantage of the present apparatus is the reduction in air pollution caused by sugar mills. Presently, sugar mills add water to the bagasse derived from the crushing of the sugar cane to aid in the recovery of the available sugar. The in-field processor results in the supply of undiluted sugar cane juice to the sugar mill. This juice is suitable for processing, requiring no addition of water. In effect, such a system will reduce water usage in the mill and result in less air pollution from the mill due to the fact that less water needs to be then driven off the juice.

Use of the apparatus has the potential to significantly reduce the negative environmental effects associated with the need of the industry to dispose of large quantities of centrally located surplus fibrous matter.

The present invention covers all the possible variations and permutations for separating all the constituent parts of a juice-containing product in the field where the useable products, either in part or fully or a combination of such, are extracted and dispatched to further processing facilities or final market and the other parts returned to the field either alone or with other field treatment products, for example fertilizers or chemical or biological control agents, after the required parts are extracted.

The harvested cane can be delivered to the inlet means of the in-field processor directly from the harvester to a processor installed in the harvester. In another embodiment, the harvested cane can be delivered to the inlet means of a separate processor operating in tandem with the harvester. In another embodiment, the processor can be a stand alone machine to which the harvested plant matter is delivered. The harvested cane can be delivered by cane transporters or another transport method, such as a conveyor, working in conjunction with the harvester.

The comminuting means in one embodiment can comprise a series of cutting blades, cutting knives or cutting disks. In another embodiment, the comminuting means can comprise a series of chopper knives or a shredding device. In a still further embodiment, the comminuting means can comprise a crusher, such as a ball or roller crusher. In yet a further embodiment, the comminuting means can comprise a combination of any or all of the previously mentioned devices for reducing the juice-containing plant matter to a size consistent with efficient juice extraction and consistent with efficient rupturing of the plant cell wall to release the juice.

The ruptured cells of the plant matter are then passed through the separating means. In one embodiment, the separating means can comprise a series of squeezing rollers. In another embodiment, the separating means can comprise a belt press. In a still further embodiment, the separating means can comprise a centrifuge. In yet a further embodiment, the separating means can comprise a chemical extraction. In still yet a further embodiment, the separating means can comprise any one of the devices described above for separating the juice from the cells.

Once the juice is extracted from the plant matter, it is then transported to the mill for processing or even to an in-field processing plant.

The in-field processor in one embodiment would return all the products of the harvesting to the field and extract only the juices, sugar and/or sucrose juices.

The in-field processor in another embodiment would allow the harvestable juicable products to be separated into their various components and the separate components, either alone or in combination, be selected for further processing or returned to the field. For example, the bagasse may be delivered to a maceration bath or subjected to imbibition where residual sugars are absorbed into the liquid prior to recompression and finally returned to the field. This level of processing may occur in the in-field machine or be an additional stand alone treatment. Such further processing may or may not be included in the final process, depending on the economic advantage of such additional treatment compared to the quantities of diluted juice recovered and the additional cost of water removal to obtain the recovered sugars. One advantage of this embodiment is that the undiluted juice is able to be kept separate. The example of the apparatus and method provided below does not include imbibition or maceration processing.

The in-field processor in another embodiment could also process the juices to their final constituent components. In one embodiment, it would produce for example, sugar crystals, molasses or other marketable products in the one machine. In another embodiment, the juice would be extracted in one machine and the further processing of the juice to produce for example, sugar crystals, molasses or other marketable products, would be performed in a separate in-field located machine.

### BRIEF DESCRIPTION OF THE DRAWINGS

One embodiment of the apparatus and method according to the present invention is now described with reference to the accompanying drawings, in which:

FIG. 1 is a process flow diagram of a processor according to the invention interconnected to a known form of sugar cane harvester;

FIG. 2 is a plan view of the processor;

FIG. 3 is a side elevational view of the processor;

FIG. 4 is a cross-sectional view through A-A of the processor depicted in FIG. 3; and

FIG. 5 is a simplified pictorial view of the processor.

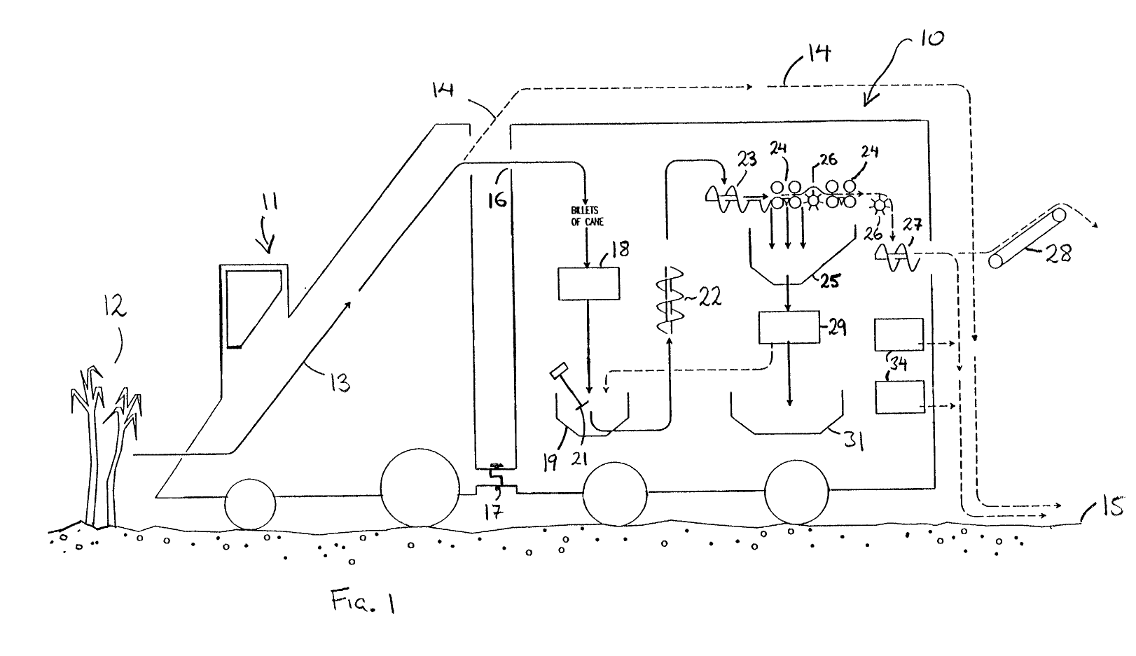

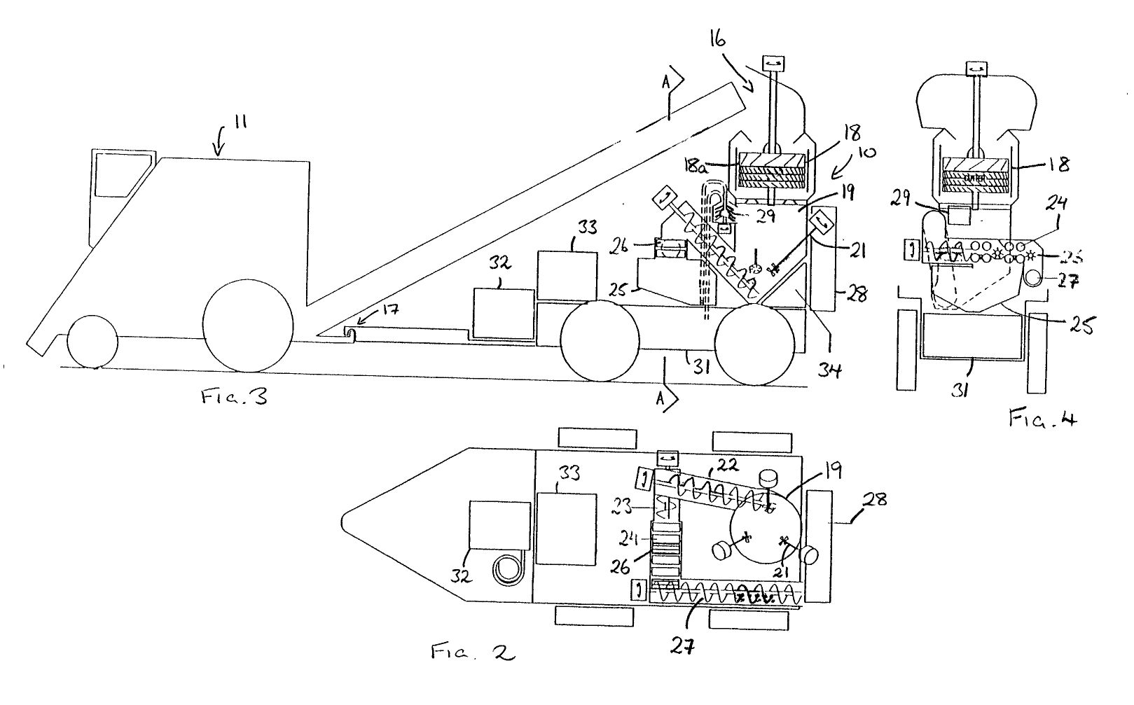

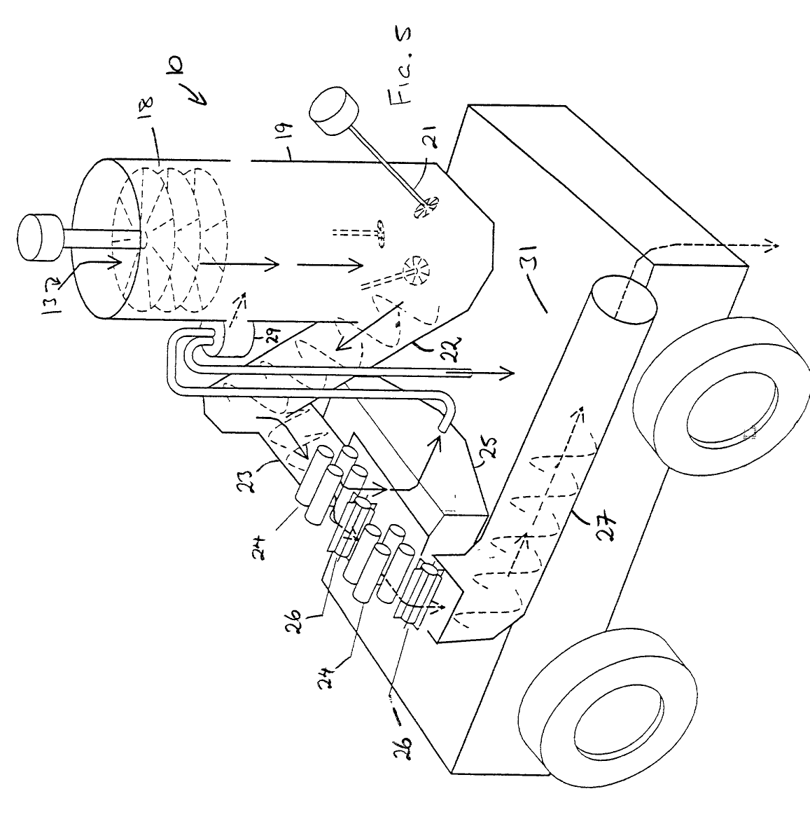

### PREFERRED MODE OF CARRYING OUT THE INVENTION

In the description of the processor and its use provided below, only the main processor components have been described. Standard engineering applications, such as for example, machine body, drive trains, hydraulics, electrics, pumping systems, feed systems, controls, control circuits, piping, and the like have not been detailed as it is the process and the general design of the apparatus that can comply with the objectives of the invention that is critical.

In the depicted embodiment, the processor 10 is depicted as being interconnected to and towed through a coupling 17 at the rear of a known type of cane harvester 11. Such a harvester 11 normally includes a base cutter that severs the cane 12 proximate the ground. The severed cane 12 is then fed through the harvester 11 along feedpath 13 past chopper drums or the like which chop the cane 12 into billets that are then fed through an inlet 16 into the processor 10. Any waste plant refuse that is not to be processed with the billets is blown by the harvester out of feedpath 13 and into a separate feedpath 14. The waste plant refuse will typically be blown directly onto the field 15 by the harvester 11.

While in the depicted embodiment, the sugar cane billets are delivered to a processor 10 being towed by the harvester 11, it will be appreciated that the processor could operate in tandem with the harvester 11. For example, the processor 10 could be towed by or be mounted on a separate farm vehicle that moves through the field beside the harvester 11. In another embodiment, the billets produced by the harvester 11 could be loaded into a receiving bin and then transported or fed by a feeder system to a separately located processor 10 that is installed in or near the field of harvest of the cane 12.

While not shown in the depicted embodiment, the processor 10 can include, in any of its embodiments, a billet washing step or other pre-treatment step that ensures the billets are in appropriate form before undergoing the remainder of the processing provided by the processor 10.

Once the billets have passed into the processor 10, they are fed into the top of a cutter stack 18 of feeder and cutter disks 18a. The cutter stack 18 includes an uppermost feeder disk that is rotated at a selected rate to ensure that the cane billets are pressed against the first cutter disk in the stack 18. The cutter disk can rotate in either the same or opposite direction and at a higher revolution rate compared to the feeder disk. The cutter disk cuts the cane billets into small pieces which are then fed to the next feeder disk in the stack 18 which ensures the cane billets are pressed appropriately against the next cutting disk. This process is repeated through the stack with the actual number of feeder and cutting disks in the stack 18 dependent on cane conditions and equipment design, i.e. speed of cutter disk rotation, cutter blade design and number etc. In one embodiment, the second or subsequent feeder disk may be replaced by a counter rotating cutter disk if this proved to be a better option for appropriately comminuting the cane. The billets need at least to be passed through a sufficient number of cutter disks to ensure that the cane is reduced to a size where most of the juice-containing cells in the cane are ruptured.

The cut cane fiber and juice falls into, or is delivered by any other necessary means, to a pulp chamber 19. The cut fiber and juice collects in the chamber 19 where a series of high speed rotating cutter blades 21 continue to further finely comminute the pulp mass collecting in the chamber 19 with the aim of facilitating further cell wall cutting or rupturing. This further comminution of the pulp mass leads to the chamber 19 gradually filling with a cane slurry. As the pulp mass becomes saturated with fibers, some may float so ensuring that they are further processed by the high speed rotating cutter blades 21.

A screw extractor 22 is used to remove fibre from the pulp mass in the chamber 19. The screw extractor 22 lifts the cane fibres from the pulp mass whilst allowing any excess juice to run back into the chamber 19. The extracted fibers are discharged from the top of the screw extractor 22 into a roller feeder 23. The excess juice that remains in the chamber 19 does so until the liquid level reaches a position where the time taken to extract the fiber is too short to allow the excess juice to run back to the pulp chamber area. As the level of juice rises in the pulp chamber, excess juice is then carried over with the extracted fiber to the roller feeder screw 23.

The extracted fiber and any juice is fed by the roller feeder screw 23 to a first set of juice extraction rollers 24. The extracted fiber is concentrated and compressed by rollers 24 in such a manner that any juice carried with the fiber is squeezed out and collects in a juice/pulp chamber 25 disposed below the rollers 24. While chamber 25 is adapted to collect cane juice, it is anticipated that some carry over fiber and other residual matter will collect in the chamber 25.

The squeezed fiber or bagasse is also passed through a shredder 26, then through a further set of rollers 24 and a still further shredder 26 before it is conveyed to a discharge screw 27 that ejects the bagasse from the processor 10. Prior to ejection, fertilizers or chemicals may be added from storage tank or tanks 34 to the discharge stream. The ejected bagasse may be discharged directly onto the field 15 by the processor 10. If the processor is a stationary unit then the bagasse can be discharged by screw 27 onto a discharge conveyor 28 that conveys the bagasse to a bin or other receptacle ready for appropriate disposal or sale. The bagasse shredders 26 may not need to be used in the processor 10 if the bagasse is still destined for transport to a sugar mill or is to be used as a feedstock for cattle or in the production of fertilizer.

A centrifuge 29 drawing juice from the chamber 25 separates the fiber and other residual matter from the undiluted juice, and returns this fiber and other residual matter back to the pulp chamber 19 for reprocessing and eventual discharge with the bagasse.

The undiluted juice from the centrifuge 29 is discharged into the on-board juice tank 31. The juice in the tank 31 can be regularly transferred to a main storage tanker using pump 32 for transport to a mill for further processing or to an in-field or near-field mill for processing. The discharge could be as and when the tank becomes full or by a continuous umbilical permanently or regularly connecting the processor to in-field storage or processing plant or, for example, the existing centralised milling facility.

The processor 10 will have a suitable power pack 33 mounted thereon to drive the machinery of the processor 10.

Although the depicted embodiments incorporates features such as cutting disks, cutting blades, juice extraction rollers and screw conveyors, the actual combination of equipment that could be utilized to achieve the objectives of the invention may vary from that depicted. For example, the cutting disks could be replaced by chopper blades or ball rollers or a combination of both, subject to the comminuting means being suitable for rupturing the juice-containing cells of the cane billets. In one embodiment, for example, the cutter blades 21 may not be necessary if the cutter stack 18 adequately ruptures the cells of the cane billets. In another embodiment, the cutting blades may play a significant role in achieving necessary comminution of the cane billets after the cutter stack 18 has roughly cut the cane billets to a manageable size.

In an alternative embodiment, the juice extracting rollers 24 may be replaced by a belt press or a centrifuge or centrifuges, or a combination of rollers and centrifuge or even ball rollers.

Once the juice is extracted, it can be clarified, filtered, and/or strained in the processor 10. The resultant liquid can also be converted into raw sugar by, for example, a vacuum microwave heating system to remove the water component of the liquid. The vacuum microwave heating system can be integrated into the processor 10 or can comprise a separate stand alone unit. The raw sugar can then be centrifuged to remove the molasses component as required. The sugar components, either individually, or with any combination or at any stage of the in-field process, as required, can be delivered to either a mill for separation, or to a refinery for turning into granulated sugar, brown sugars, syrups, and the like.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An apparatus for extracting sugar-containing juice from sugar-containing plant matter, the apparatus comprising:
an inlet means for receiving the plant matter;
a comminuting means for finely comminuting the received plant matter; and
a separating means for separating the sugar-containing juice from the finely comminuted plant matter.

2. The apparatus of claim 1 wherein the comminuting means comprises a cutter means.

3. The apparatus of claim 2 wherein the cutter means comprises at least one cutting blade and/or at least one cutting disk.

4. The apparatus of claim 3 wherein the cutter means comprises a plurality of rotatable cutting disks.

5. The apparatus of claim 4 wherein the cutting disks are mounted to a substantially vertical and rotatable drive shaft.

6. The apparatus of claim 5 wherein at least one of the cutting disks is adapted to rotate in an opposite direction to that of the other cutting disks.

7. The apparatus of claim 4 wherein the comminuting means comprises a feeding means adapted to feed the plant matter through the cutter means.

8. The apparatus of claim 7 wherein the feeding means comprises at least one rotatable feeding disk disposed adjacent at least one of the cutting disks.

9. The apparatus of claim 8 wherein said at least one feeding disk is disposed immediately above an uppermost cutting disk.

10. The apparatus of claim 8 wherein at least one feeding disk is disposed above each of the cutting disks of the comminuting means.

11. The apparatus of claim 8 wherein said at least one feeding disk rotates in an opposite direction to that of at least one of its adjacent cutting disks.

12. The apparatus of claim 1 wherein the comminuting means comprises a series of chopping knives, a shredding means and/or a crushing means.

13. The apparatus of claim 1 wherein the comminuting means is disposed in a first chamber having the inlet means at an upper end thereof such that the finely comminuted plant matter is adapted to fall into the chamber.

14. The apparatus of claim 13 wherein the chamber comprises at least one further cutter means disposed adjacent its lower end and adapted to further comminute the plant matter once it is in the chamber.

15. The apparatus of claims 13 wherein an extraction means is adapted to extract the finely comminuted plant matter from the first chamber and transport it to the separating means.

16. The apparatus of claim 15 wherein the extraction means comprises a screw extractor.

17. The apparatus of claim 1 wherein the separating means comprises a centrifuge.

18. The apparatus of claim 1 wherein the separating means comprises a series of rollers for pressing the comminuted plant matter passed therethrough.

19. The apparatus of claim 1 wherein the separating means comprises a chemical separating process.

20. The apparatus of claim 1 wherein the separating means comprises a roller feeding device that feeds the finely comminuted plant matter into the separating means, a plurality of extraction rollers that extract sugar-containing juice from the plant matter, a chamber for storing at least the extracted sugar-containing juice, and a centrifuge for further processing of the juice.

21. The apparatus of claim 20 wherein the centrifuge has an outlet for the separated sugar-containing juice and an outlet for any plant matter that enters the centrifuge.

22. The apparatus of claim 21 wherein the outlet for the plant matter feeds the plant matter back to the first chamber.

23. The apparatus of claim 21 wherein the outlet for the juice is in fluid communication with a storage container for the juice.

24. The apparatus of claim 20 wherein the separating means further comprises a shredding means for shredding the plant matter that has passed through the extraction rollers, and at least one further set of extraction rollers.

25. The apparatus of claim 24 further comprising a plant matter extraction means downstream of the separation means.

26. The apparatus of claim 25 wherein the plant matter extraction means comprises a screw extractor.

27. The apparatus of claim 1 wherein the apparatus comprises part of a harvester for the plant matter.

28. The apparatus of claim 27 wherein the harvester is a sugar cane harvester.

29. The apparatus of claim 1 wherein the apparatus further comprises an apparatus for extracting raw sugar from the separated sugar-containing juice.

30. A process of extracting sugar-containing juice from sugar-containing plant matter using an apparatus having at least an inlet means for receiving the plant matter, a comminuting means for finely comminuting the received plant matter, and a separating means for separating the sugar-containing juice from the finely comminuted plant matter, the process comprising the steps of:
feeding the plant matter to the inlet means;
finely comminuting the plant matter by passing it through the comminuting means; and
separating the sugar-containing juice from the plant matter in the separating means.

31. The process of claim 30 wherein the step of finely comminuting the plant matter comprises passing the plant matter through at least one cutting disk.

32. The process of claim 30 wherein the step of separating the juice from the finely comminuted plant matter comprises passing the plant matter through at least a series of rollers, a centrifuge, and/or a chemical process.

33. The process of claim 30 wherein the plant matter is sugar cane and the process comprises the steps of firstly harvesting the cane and cutting it into billets before undergoing the step of fine comminution.

34. The process of claim 33 wherein the process is performed at the site of harvesting of the sugar cane.

35. The process of claim 34 wherein the plant matter is discharged from the apparatus back to the site of harvesting after the juice is separated therefrom.

36. The process of claim 30 wherein the juice undergoes further processing to extract raw sugar therefrom.
